(19) United States
(12) Patent Application Publication
(10) Pub. No.: US 2015/0247761 A1
(43) Pub. Date: Sep. 3, 2015

(54) TEMPERATURE DETECTION DEVICE AND SEMICONDUCTOR MANUFACTURING APPARATUS

(71) Applicant: Kabushiki Kaisha Toshiba, Minato-ku (JP)

(72) Inventor: Shinji MIYAZAKI, Mie (JP)

(73) Assignee: Kabushiki Kaisha Toshiba, Minato-ku (JP)

(21) Appl. No.: 14/482,063

(22) Filed: Sep. 10, 2014

(30) Foreign Application Priority Data
Feb. 28, 2014 (JP) 2014-039470

(51) Int. Cl. G01K 7/02; F27D 21/00

(52) U.S. Cl. CPC G01K 7/02; F27D 21/0014

(57) ABSTRACT

According to one embodiment, a temperature detection device includes a plurality of thermocouples, an insulating member, and an exterior protective tube. The thermocouple is configured to include two measurement wires as a pair. The two measurement wires are joined at a temperature measuring contact point. The insulating member is formed with a plurality of through-holes. The insulating member holds the plurality of thermocouples. In each of the plurality of thermocouples, each of the measurement wires is inserted to different through-hole so that the measurement wires are insulated from each other. The exterior protective tube interiorly accommodates the thermocouples and the insulating member.

### CROSS-REFERENCE TO RELATED APPLICATIONS

This application is based upon and claims the benefit of priority from Japanese Patent Application No. 2014-039470, filed on Feb. 28, 2014; the entire contents of all of which are incorporated herein by reference.

### FIELD

Embodiments described herein relate generally to a temperature detection device and a semiconductor manufacturing apparatus.

### BACKGROUND

A heater that controls the temperature in a reaction tube is arranged in a heat treating furnace (heat treating film forming device) of a semiconductor manufacturing apparatus. The speed of the film forming reaction differs depending on the temperature. The heat treating furnace causes variation in the thickness of the produced film according to the temperature difference for every position where the substrate is arranged. The heater controls the supply of heat to the reaction tube according to the detection result in the temperature detection device to ensure a uniform temperature distribution among a plurality of substrates.

As one of the temperature detection devices used in the heat treating furnace of the semiconductor manufacturing apparatus, the device including a thermocouple is known. Temperature detection devices that measure the temperature at a plurality of positions in a vertical direction include a temperature detection device with a plurality of thermocouples in which the respective lengths are adjusted so that the position of a temperature measuring contact point of the thermocouple coincides with the position of measuring the temperature. The plurality of thermocouples is accommodated in a cylindrical protective tube with a measurement wire of each thermocouple insulated from each other. Each measurement wire is passed through an insulating insulator tube for preventing conduction by the contact between the measurement wires.

Since the positions of the plurality of thermocouples in the protective tube are not fixed, the position relationship with respect to each other in the circumferential direction of the protective tube sometimes changes. In this case, it becomes difficult for the temperature detection device to carry out precise management of the measurement accuracy as the position of each thermocouple with respect to the heater has a possibility of changing as needed.

### BRIEF DESCRIPTION OF THE DRAWINGS

FIG. 1 is a cross-sectional schematic view illustrating a configuration of a semiconductor manufacturing apparatus including a temperature detection device according to a first embodiment;

FIG. 2 is a view illustrating a configuration of the temperature detection device;

FIG. 3 is a perspective view illustrating a configuration of an insulating member according to the first embodiment;

FIG. 4 is a view illustrating a cross-sectional configuration of the temperature detection device and a state of propagation of heat from the heater;

FIG. 5 is a view illustrating a cross-sectional configuration of the temperature detection device and a state of propagation of heat from the heater according to a comparative example of the embodiment;

FIG. 6 is a view illustrating change in a position of the thermocouple, and change in the measurement result of the temperature;

FIG. 7 is a view illustrating a configuration of a temperature detection device according to a second embodiment; and

FIG. 8 is a view illustrating a configuration of a temperature detection device according to a third embodiment.

### DETAILED DESCRIPTION

In general, according to one embodiment, a temperature detection device includes a plurality of thermocouples, an insulating member, and an exterior protective tube. The thermocouple is configured to include two measurement wires as a pair. The two measurement wires are joined at a temperature measuring contact point. The insulating member is formed with a plurality of through-holes. The insulating member holds a plurality of thermocouples. The plurality of thermocouples has each of the measurement wires inserted to different through-holes so that the measurement wires are insulated from each other. The exterior protective tube interiorly accommodates the thermocouples and the insulating member.

Exemplary embodiments of a temperature detection device and a semiconductor manufacturing apparatus will be described below in detail with reference to the accompanying drawings. The present invention is not limited to the following embodiments.

### First Embodiment

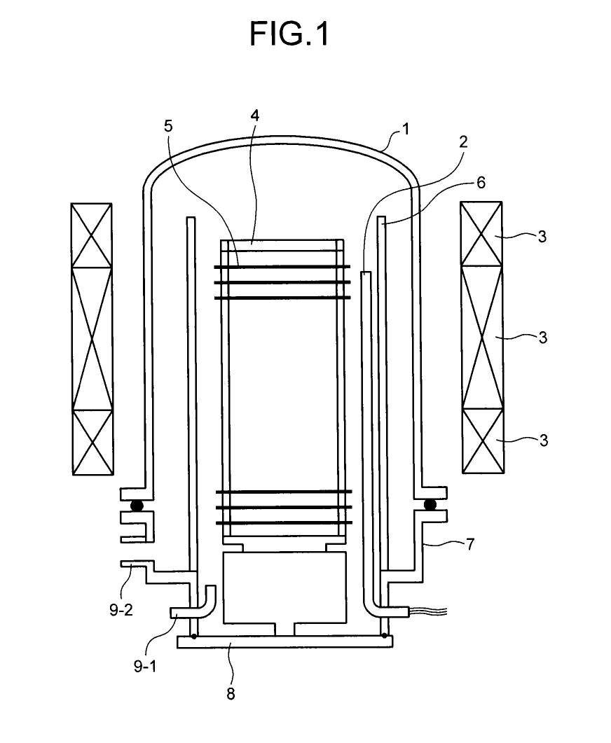

FIG. 1 is a cross-sectional schematic view illustrating a configuration of a semiconductor manufacturing apparatus including a temperature detection device according to a first embodiment. The semiconductor manufacturing apparatus includes an outer tube 1, a temperature detection device 2, a heater 3, a substrate supporting unit 4, an inner tube 6, a furnace opening flange 7, and a cap 8. The semiconductor manufacturing apparatus makes vapor phase grows on a crystal film over a surface of a substrate 5.

The inner tube 6, which is a reaction tube, is placed at the interior of the outer tube 1. The inner tube 6 configures a space in which a reaction process on the substrate 5 is performed. The outer tube 1 and the inner tube 6 are configured using a quartz member, for example. The reaction gas for forming a film to the substrate 5 is introduced to the inner tube 6 through a gas introducing tube 9-1.

The outer tube 1 is supported on the furnace opening flange 7. The cap 8 seals a lower opening of the furnace opening flange 7. The furnace opening flange 7 includes an exhaust port 9-2. The reaction gas introduced to the inner tube 6 is discharged to an exhaust path from the exhaust port 9-2.

The substrate supporting unit 4 is placed on the cap 8 at the interior of the inner tube 6. The substrate supporting unit 4 supports the substrate 5 in a space in the inner tube 6 where the reaction process is performed. The substrate supporting unit 4 has a multi-stage shelf structure in which a plurality of substrates 5 in a horizontal posture can be mounted. The substrate supporting unit 4 holds the plurality of substrates 5 in a vertically arrayed state.

The heater 3 is placed at a periphery of the outer tube 1. The heater 3 supplies heat to the substrate 5 at the interior of the inner tube 6 via the outer tube 1 and the inner tube 6. The temperature detection device 2 is provided at the interior of the inner tube 6. The temperature detection device 2 detects the temperature.

The semiconductor manufacturing apparatus introduces SiH₄, for example, to the inner tube 6 as the reaction gas. The semiconductor manufacturing apparatus performs the reaction process that uses the reaction gas in the space in the inner tube 6 to generate a film on the substrate 5 being heated, using the heater 3. The semiconductor manufacturing apparatus collectively performs the film forming process on the plurality of substrates 5 installed in the inner tube 6.

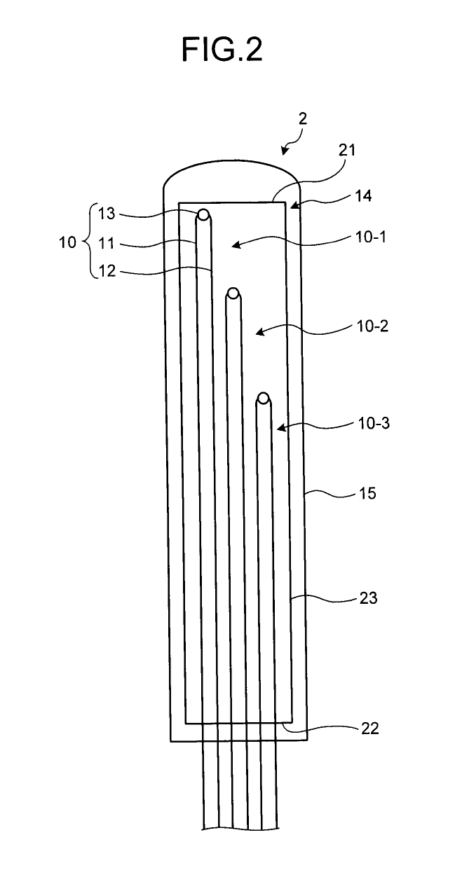

FIG. 2 is a view illustrating a configuration of the temperature detection device. The temperature detection device 2 includes a plurality of thermocouples 10, an insulating member 14, and an exterior protective tube 15. The exterior protective tube 15 has a cylindrical shape. The exterior protective tube 15 is configured using a quartz member, for example.

The exterior protective tube 15 interiorly accommodates the plurality of thermocouples 10 and the insulating member 14. FIG. 2 illustrates a side surface configuration of the temperature detection device 2. In such side surface configuration, the plurality of thermocouples 10 and the insulating member 14 covering each of the thermocouples 10 arranged at the interior of the exterior protective tube 15 are illustrated with a solid line.

The thermocouple 10 is configured to include two measurement wires 11 and 12 as a pair. One end of the measurement wire 11 and one end of the measurement wire 12 are joined with a temperature measuring contact point 13. The measurement wires 11 and 12 are conductive wires made from a metal material. The measurement wire 11 and the measurement wire 12 are made from a metal material different from each other. The measurement wires 11 and 12 are extended downward in parallel from the temperature measuring contact point 13.

Every thermocouple 10 has the temperature measuring contact point 13 positioned in the interior of the insulating member 14. The side opposite to the temperature measuring contact point 13 of the measurement wire 11 and 12 is pulled out to the exterior of the insulating member 14 and the exterior protective tube 15. The measurement wires 11 and 12 are respectively connected to a measurement circuit (not illustrated) through a compensation lead wire.

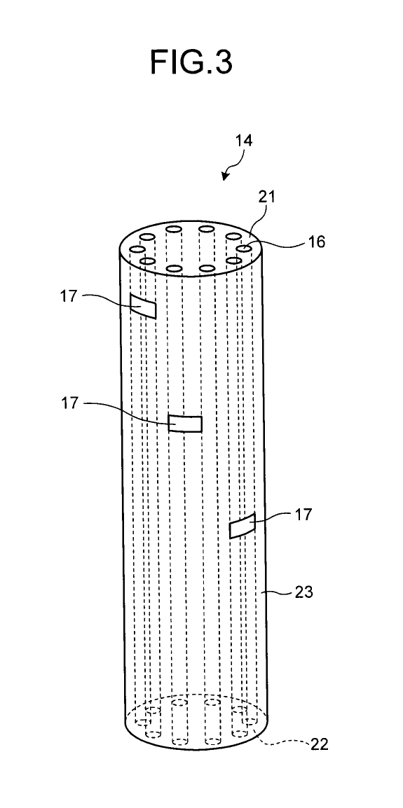

FIG. 3 is a perspective view illustrating a configuration of the insulating member according to the first embodiment. The insulating member 14 has a circular column shape. The insulating member 14 is configured using a quartz member, for example. The insulating member 14 is formed with a plurality of through-holes 16. Each through-hole 16 is passed through the insulating member 14 in an up and down direction from an upper end face 21 to a lower end face 22 of the insulating member 14. The through-holes 16 are formed to be parallel to each other. The insulating member 14 may be made from any member having insulation property and heat conductivity.

One of each of the measurement wires 11 and 12 is inserted to each through-hole 16. The insulating member 14 insulates the measurement wires 11 and 12 inserted to the through-holes 16 different from each other. The insulating member 14 holds the plurality of thermocouples 10 insulated from each other. An introduction port 17 is formed at a side surface 23 of the insulating member 14. The introduction port 17 is an opening formed from the side surface 23 of the insulating member 14 to each through-hole 16, to which the pair of measurement wires 11 and 12 of the thermocouples 10 are inserted. In FIG. 2, the illustration of the through-hole 16 and the introduction port 17 is not illustrated intentionally.

The outer tube 1 can be divided into a plurality of regions in a vertical direction, for example, and the heater 3 can control heating for every region. The plurality of thermocouples 10 are arranged with the respective positions of the temperature measuring contact point 13 in the vertical direction different from each other.

A thermocouple 10-1 of the plurality of thermocouples 10 is placed such that the temperature measuring contact point 13 is located at a position closest from the upper end face 21. The position in the vertical direction of such temperature measuring contact point 13 is, for example, set in accordance with a region positioned the highest of the plurality of regions in which the heating by the heater 3 is controlled.

A thermocouple 10-2 is placed such that the position of the temperature measuring contact point 13 is located lower than the temperature measuring contact point 13 of the thermocouple 10-1. The position in the vertical direction of the temperature measuring contact point 13 of the thermocouple 10-2 is, for example, set in accordance with a region positioned at the middle of the plurality of regions in which the heating by the heater 3 is controlled.

A thermocouple 10-3 is placed such that the position of the temperature measuring contact point 13 is located lower than the temperature measuring contact point 13 of the thermocouple 10-2. The position in the vertical direction of the temperature measuring contact point 13 of the thermocouple 10-3 is, for example, set in accordance with a region positioned the lowest of the plurality of regions in which the heating by the heater 3 is controlled.

The temperature detection device 2 is not limited to a device including, as the plurality of thermocouples 10, the thermocouples 10-1, 10-2, 10-3 in which the positions of the temperature measuring contact point 13 in the vertical direction are different from each other. The number of thermocouples 10 and the positions of the temperature measuring contact point 13 may be appropriately changed. In each thermocouple 10, the lengths of the measurement wires 11 and 12 are appropriately set so that the temperature measuring contact point 13 is located at a desired position.

The measurement wires 11 and 12 of the plurality of thermocouples 10 are respectively inserted to the through-hole 16 in the insulating member 14. The insulating member 14 thus insulates the thermocouples 10, and also interiorly holds the plurality of thermocouples 10.

The introduction port 17 is formed in accordance with the position of each temperature measuring contact point 13 of the thermocouples 10-1, 10-2, 10-3, for example. The thermocouples 10-1, 10-2, 10-3 are installed at predetermined positions in the insulating member 14 by inserting the measurement wires 11 and 12 to the through-holes 16 from the introduction port 17. The number and position of the introduction port 17 can be appropriately changed according to the number and position of the thermocouple 10.

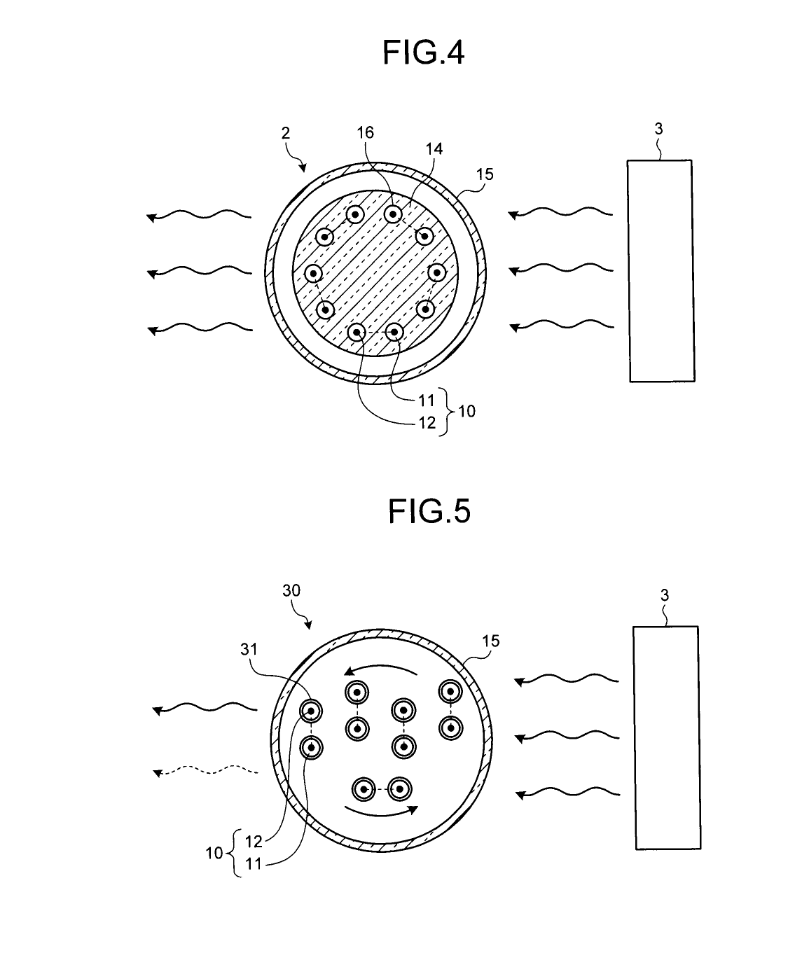

FIG. 4 is a view illustrating a cross-sectional configuration of the temperature detection device and a state of propagation of heat from the heater. FIG. 5 is a view illustrating a cross-sectional configuration of the temperature detection device and a state of propagation of heat from the heater according to a comparative example of the embodiment.

A temperature detection device 30 according to the comparative example includes an insulating insulator tube 31. For example, the insulating insulator tube 31 is configured with a ceramic member such as alumina. A plurality of insulating insulator tubes 31 is arranged in a line with respect to each of the measurement wires 11 and 12. Each thermocouple 10 has each of the measurement wires 11 and 12 passed through the plurality of insulating insulator tubes 31, and enter into the exterior protective tube 15. The insulating insulator tube 31 insulates the measurement wire 11 and the measurement wire 12 of the thermocouple 10, and also insulates the thermocouples 10.

The heat conductivity in the temperature detection device 30 corresponds to the heat permeability of an element configuring the temperature detection device 30. The alumina configuring the insulating insulator tube 31 has low heat permeability compared to the quartz member configuring the exterior protective tube 15. In the exterior protective tube 15, the thermocouple 10, in which a path of propagating the heat from the heater 3 is located at a position of being shielded by another thermocouple 10, is subjected to the influence of heat capacity of the insulating insulator tube 31 arranged in the other thermocouple 10.

The measurement wires 11 and 12 are stretched when the heat from the heater 3 is received and the temperature is raised. Thereafter, when the supply of heat from the heater 3 is stopped and the temperature is lowered, the measurement wires 11 and 12 are contracted. When such stretching and contraction repeatedly occur in each thermocouple 10, each thermocouple 10 is subjected to the influence from the movement of the insulating insulator tube 31, and hence the respective measurement positions in the circumferential direction of the exterior protective tube 15 may change in each thermocouple 10.

When the position of each thermocouple 10 is changed, change in the manner of receiving the influence of the heat capacity of the insulating insulator tube 31 arranged in another thermocouple 10 may be changed in each thermocouple 10. In this case, the precise management of the measurement accuracy becomes difficult in the temperature detection device 30.

The temperature detection device 2 according to the embodiment illustrated in FIG. 4 uses the insulating member 14 to insulate the measurement wires 11 and 12, thereby suppressing change in the position relationship of the thermocouples 10. The temperature detection device 2 can obtain satisfactory insulation property and heat permeability between the thermocouples 10 in the exterior protective tube 15 by applying the insulating member 14 configured with the quartz member. The temperature detection device 2 can reduce the influence of heat capacity by using the relevant insulating member 14 compared to when using the insulating insulator tube 31. Thus, the temperature detection device 2 has effects in that the precise management of the measurement accuracy can be carried out and the temperature can be accurately measured.

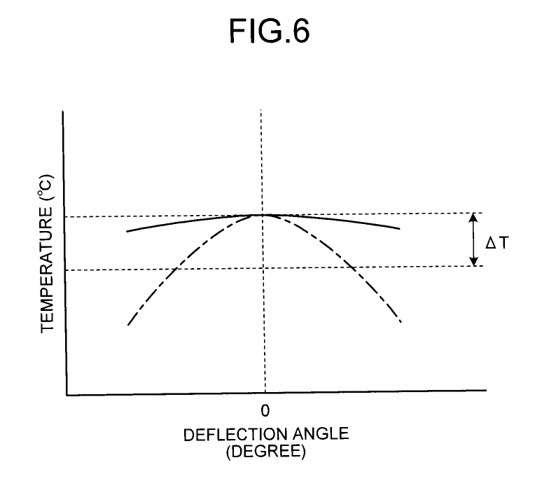

Next, an effect of adopting the quartz member of high heat permeability for the insulating member 14 will be described. FIG. 6 is a view illustrating change in the position of the thermocouple and change in the measurement result of the temperature. Here, the change in the position of the thermocouple 10 in the direction of the cross-section of the exterior protective tube 15 is expressed as a deflection angle (rotation angle) having the center position of the exterior protective tube 15 as a center.

In FIG. 6, a curve indicated with a solid line represents the relationship of the measurement result and the deflection angle in the temperature detection device 2 of the present embodiment. A curve indicated with a chain dashed line represents the relationship of the measurement result and the deflection angle in a care where the insulating insulator tube 31 is used in place of the insulating member 14.

The temperature detection device 2 can suppress the change in the measurement result with respect to the change in the deflection angle by adopting the quartz member, having high heat permeability compared to the alumina configuring the insulating insulator tube 31, for the insulating member 14. For example, when the measurement accuracy in which the variation range of the measurement result is within AT (e.g., 0.3° C.) is required for the temperature detection device 2, the temperature detection device 2 can sufficiently obtain the relevant measurement accuracy.

### Second Embodiment

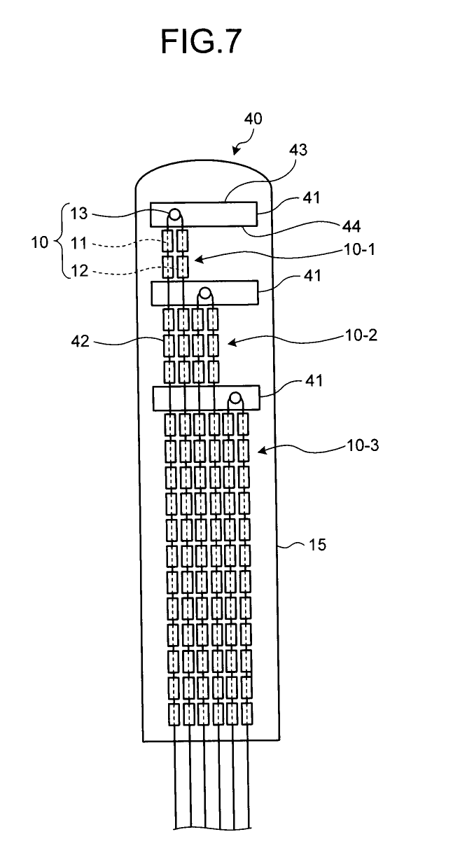

FIG. 7 is a view illustrating a configuration of a temperature detection device according to a second embodiment. The same reference numerals are assigned on the components same as the first embodiment, and the redundant description will be appropriately omitted. A temperature detection device 40 includes a plurality of thermocouples 10, a plurality of insulating members 41, and an exterior protective tube 15. The exterior protective tube 15 interiorly accommodates the plurality of thermocouples 10, the plurality of insulating members 41, and a plurality of insulating insulator tubes 42.

The insulating member 41 is placed at each position of a temperature measuring contact point 13 of the plurality of thermocouples 10. The insulating member 41 has a circular plate shape. The insulating member 41 is configured using a quartz member, for example. The insulating member 41 is formed with a plurality of through-holes (not illustrated). Each through-hole is passed through the insulating member 41 in the up and down direction from an upper surface 43 to a lower surface 44 of the insulating member 41. The through-holes are formed to be parallel to each other. The insulating member 41 may be made from any member having insulation property and heat conductivity.

One of each of measurement wires 11 and 12 is inserted to each through-hole. The insulating member 41 insulates the measurement wires 11 and 12 inserted to the through-holes, and holds the thermocouple 10.

The portion other than the portion passed through the insulating member 41 of the measurement wires 11 and 12 is passed through the plurality of insulating insulator tubes 42. The plurality of insulating insulator tubes 42 are arranged in a line with respect to each of the measurement wires 11 and 12. For example, the insulating insulator tube 42 is configured with a ceramic member such as alumina. The insulating insulator tube 42 insulates the measurement wire 11 and the measurement wire 12 of the thermocouple 10, and insulates the thermocouples 10.

The insulating member 41 is placed at a position of each temperature measuring contact point 13 of each of thermocouples 10-1, 10-2, and 10-3, for example. Every thermocouple 10-1, 10-2, and 10-3 has the temperature measuring contact point 13 positioned in the interior of the insulating member 41. The insulating member 41 holds the thermocouples 10-1, 10-2, and 10-3 so that the temperature measuring contact point 13 is arranged for every region the heating by the heater 3 is controlled.

According to the second embodiment, the temperature detection device 40 can reduce the influence of heat capacity at the position of the temperature measuring contact point 13 by arranging the insulating member 41 configured with the quartz member at the position of the temperature measuring contact point 13 of each thermocouple 10. In the second embodiment, the temperature detection device 40 also has effects in that the precise management of the measurement accuracy can be carried out, and the temperature can be accurately measured. The number and position of the insulating member 41 may be appropriately changed according to the number of thermocouples 10 and the position of the temperature measuring contact point 13.

### Third Embodiment

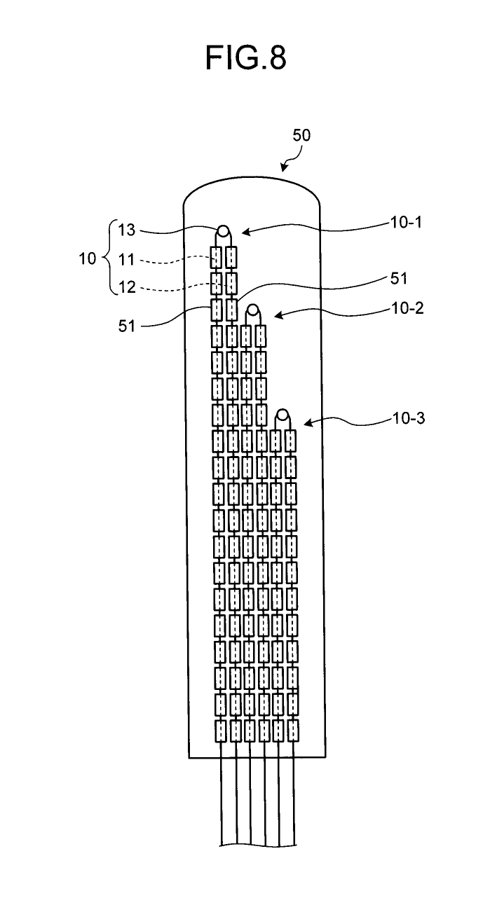

FIG. 8 is a view illustrating a configuration of a temperature detection device according to a third embodiment. The same reference numerals are assigned on the components same as the first embodiment, and the redundant description will be appropriately omitted. A temperature detection device 50 includes a plurality of thermocouples 10, a plurality of insulating insulator tubes 51 serving as insulating members, and an exterior protective tube 15.

An insulating insulator tube 51 is configured with a quartz member. The plurality of insulating insulator tubes 51 are arranged in a line with respect to each of measurement wires 11 and 12. Each thermocouple 10 has each of the measurement wires 11, 12 passed through the plurality of insulating insulator tubes 51, and enter into the exterior protective tube 15. The insulating insulator tube 51 insulates the measurement wire 11 and the measurement wire 12 of the thermocouple 10, and also insulates the thermocouples 10.

According to the third embodiment, the temperature detection device 50 can reduce the influence of heat capacity by applying the insulating insulator tube 51 configured with the quartz member, compared to when applying an insulating insulator tube made from alumina. In the third embodiment, the temperature detection device 50 also has effects in that the precise management of the measurement accuracy can be carried out and the temperature can be accurately measured.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A temperature detection device comprising:
a plurality of thermocouples configured to respectively include two measurement wires joined at a temperature measuring contact point as a pair;
an insulating member formed with a plurality of through-holes, and configured to hold the plurality of thermocouples in which each of the measurement wires is inserted to different through-hole and the measurement wires are insulated from each other; and
an exterior protective tube configured to interiorly accommodate the thermocouples and the insulating member.

2. The temperature detection device according to claim 1, wherein
an introduction port is formed on a side surface of the insulating member, the introduction port communicating to each through-hole to which each of the pair of measurement wires configuring the thermocouple is inserted; and
the thermocouples are installed in the interior of the insulating member by inserting the measurement wires from the introduction port to the through-holes.

3. The temperature detection device according to claim 1, wherein the plurality of thermocouples are arranged while differing the positions of the temperature measuring contact points.

4. The temperature detection device according to claim 2, wherein the introduction port is formed in accordance with each position of the temperature measuring contact points of the plurality of thermocouples.

5. The temperature detection device according to claim 1, wherein the insulating member is divided into parts and each of the parts of the insulating member is arranged to be distributed to positions of the temperature measuring contact points of the plurality of thermocouples.

6. The temperature detection device according to claim 5, further comprising:
insulating insulators configured to insulate the measurement wires; wherein
a portion other than a portion passed through the through-hole of the insulating member in the measurement wire is passed through the insulating insulator.

7. The temperature detection device according to claim 1, wherein the insulating member is made from a quartz material.

8. The temperature detection device according to claim 1, wherein the insulating member is made from a member having insulation property and heat conductivity.

9. The temperature detection device according to claim 1, wherein the insulating member has a circular column shape.

10. The temperature detection device according to claim 1, wherein the through-hole is passed through from an upper end face to a lower end face of the insulating member.

11. A semiconductor manufacturing apparatus comprising:
a reaction tube in which a reaction process with respect to a substrate to be accommodated is performed;
a heater configured to supply heat to an area in the reaction tube; and
a temperature detection device provided inside the reaction tube and configured to detect temperature; wherein
the temperature detection device includes,
a plurality of thermocouples configured to respectively include two measurement wires joined at a temperature measuring contact point as a pair,
an insulating member formed with a plurality of through-holes, and configured to hold the plurality of thermocouples in which each of the measurement wires is inserted to different through-hole and the measurement wires are insulated from each other, and
an exterior protective tube configured to interiorly accommodate the thermocouples and the insulating member.

12. The semiconductor manufacturing apparatus according to claim 11, further comprising:
an outer tube interiorly including the reaction tube; wherein
the outer tube is divided into a plurality of regions, and heating by the heater is controllable for each of the plurality of regions; and
the insulating member holds the plurality of thermocouples so that the temperature measuring contact points are arranged for every region.

13. The semiconductor manufacturing apparatus according to claim 11, wherein
an introduction port is formed on a side surface of the insulating member, the introduction port communicating to each through-hole to which each of the pair of measurement wires configuring the thermocouple is inserted; and
the thermocouples are installed in the interior of the insulating member by inserting the measurement wires from the introduction port to the through-holes.

14. The semiconductor manufacturing apparatus according to claim 13, wherein the introduction port is formed in accordance with each position of the temperature measuring contact points of the plurality of thermocouples.

15. The semiconductor manufacturing apparatus according to claim 13, wherein the insulating member is divided into parts and each of the parts of the insulating member is arranged to be distributed to positions of the temperature measuring contact points of the plurality of thermocouples.

16. The semiconductor manufacturing apparatus according to claim 15, further comprising:
an outer tube interiorly including the reaction tube; wherein
the outer tube is divided into a plurality of regions, and heating by the heater is controllable for each of the plurality of regions; and
the insulating member is arranged for every region.

17. The semiconductor manufacturing apparatus according to claim 15, wherein
the temperature detection device includes insulating insulators configured to insulate the measurement wires; and
a portion other than a portion passed through the through-hole of the insulating member in the measurement wire is passed through the insulating insulator.
